(19) United States
(12) Patent Application Publication
(10) Pub. No.: US 2001/0010289 A1
(43) Pub. Date: Aug. 2, 2001

(54) Constant-potential coulometric ammonia gas sensor

(75) Inventors: Hiroshi Imaya, Tokyo (JP); Hiroyuki Matsuda, Tokyo (JP)

Correspondence Address: POLLOCK, VANDE SANDE & PRIDDY, P.O. Box 19088, Washington, DC, 20036, US

(73) Assignee: Riken Keiki, Co., Ltd., Tokyo (JP)

(21) Appl. No.: 09/767,826

(22) Filed: Jan. 24, 2001

(30) Foreign Application Priority Data
Jan. 28, 2000 (JP) 2000-19456

(51) Int. Cl. G01N 27/404

(52) U.S. Cl. 204/415

(57) ABSTRACT

A cell holding an electrolyte solution of not less than 0.5 mole and not more than 2.0 moles lithium chloride, having a window sealed with a gas-permeable diaphragm holding a working electrode attached to that side thereof which faces the electrolyte solution, and also holding a counter electrode permits improving response speed in accordance with the concentration of lithium chloride.

### FIELD OF THE INVENTION

This invention relates to an ammonia gas sensor employing constant-potential coulometry.

### DESCRIPTION OF THE PRIOR ART

A constant-potential coulometric gas sensor comprises a cell containing an electrolyte solution of a basic substance on the order of 0.1 mole, the cell having a window sealed with a gas-permeable diaphragm holding a working electrode attached to that side thereof which faces the electrolyte solution, and a counter electrode, with a given amount of potential applied to the working electrode.

A gas sensor thus composed detects the presence of ammonia gas by the use of hydrogen ions corresponding to the concentration of ammonia present that are generated when ammonia passing through the diaphragm is dissolved in the solution. When the hydrogen ions diffuse across the electrodes, a reduction reaction occurs at the working electrode and the resulting electrolytic current is used as the sensor output. The problem with this gas sensor is that the speed of response to ammonia is inadequate.

### SUMMARY OF THE INVENTION

A constant-potential coulometric ammonia gas sensor according to this invention comprises a cell an electrolyte solution of not less than 0.5 mole and not more than 2.0 moles lithium chloride, the cell having a window sealed with a gas-permeable diaphragm holding a working electrode attached to that side thereof which faces the electrolyte solution, and a counter electrode, with a given amount of potential applied to the working electrode, thus generating measurement signals based on the electrolytic current corresponding to the concentration of ammonia gas present.

This ammonia gas sensor quickens the response speed in proportion to the concentration of lithium chloride without bringing about any change in detectivity.

The object of this invention is to provide a constant-potential coulometric ammonia gas sensor with high responsiveness.

### BRIEF DESCRIPTION OF THE DRAWINGS

FIG. 1 is a cross-sectional view showing a preferred embodiment of this invention. FIGS. 2(a) and 2(b) graphically show the relationships of the concentration of lithium chloride in the electrolyte solution with response time and the sensor output, respectively. FIG. 3 graphically shows the relationship between the concentration of potassium chloride in the electrolyte solution and response time.

### DESCRIPTION OF THE PREFERRED EMBODIMENTS

Now a preferred embodiment of this invention is described by reference to the accompanying figures.

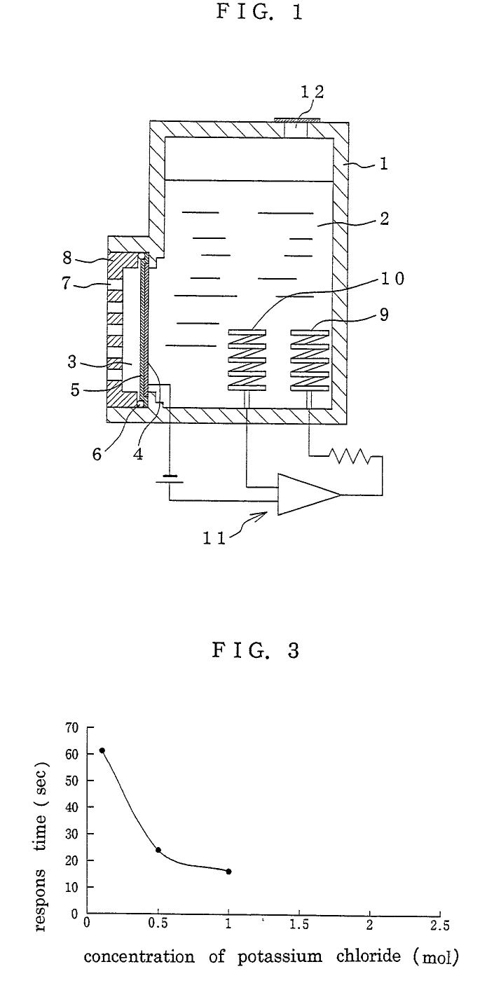

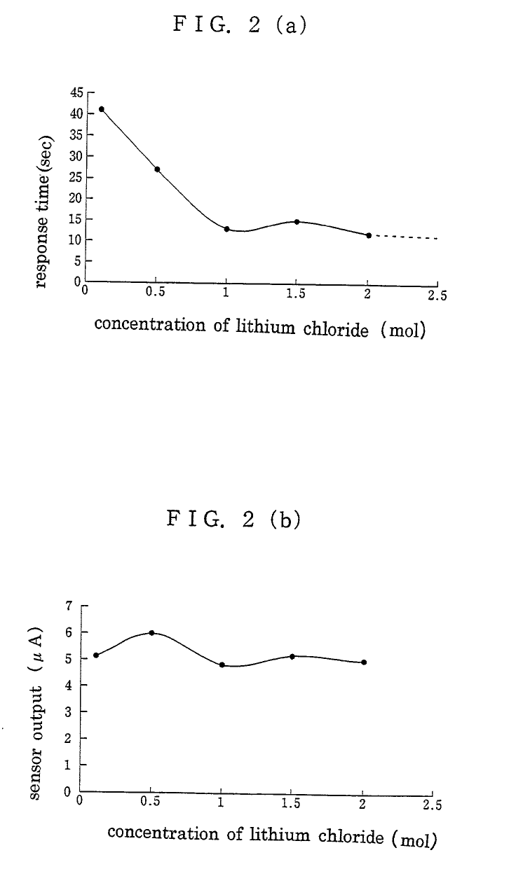

FIG. 1 shows a preferred embodiment of this invention. A cell container 1 holds an electrolyte solution 2 described later and has a through-hole 3 provided on one side thereof. On the inside of the through-hole 3, there is provided a diaphragm 5 of PTFE (polytetrafluoroethylene) or other similar substance having gas permeability and water-repellency, with a working electrode 4 formed of platinum oxide (PtO) or ruthenium oxide (PuO₂) by reactive sputtering or other method attached to the inner side thereof. The outer side of the diaphragm 5 is fastened by a retaining frame 8 having gas inlets 7, with an O-ring or other packing 6 interposed therebetween.

The cell container 1 also holds a counter electrode 9 of silver wire located at a given distance from the working electrode 4 and a reference electrode 10 of silver wire. The working electrode 4, counter electrode 9 and reference electrode 10 are led out of the container cell 1 in a liquid-tight fashion and connected to a measuring circuit 11. The potential difference at the reference electrode 10 is set at a desired level, such as between 100 and 300 millivolts. In the two-electrode design in which the counter electrode 10 serves also as the reference electrode, the counter electrode 9 is kept at a desired level.

The electrolyte solution 2 is prepared by dissolving 0.5 to 2.0 moles, which is higher than the normally used concentration of 0.1 mole, of lithium chloride widely used in the measurement of ammonia gas using constant-potential coulometric gas sensors. Reference numeral 12 designates a through-hole serving as an electrolyte inlet and also as an air passage.

In this embodiment, ammonia gas admitted through the diaphragm 5 becomes dissolved in the electrolyte solution 2 of lithium chloride and releases hydrogen ions. When the hydrogen ions diffuse to the working electrode 4, reduction reaction occurs thereat and the reducing current induced thereby is output as the concentration of ammonia gas.

FIGS. 2(a) and 2(b) respectively show the relationship between the concentration of lithium chloride in the electrolyte solution 2 and response time (the time between the time point at which ammonia gas of the normal concentration and the time point at which the reducing current falls to 60 percent saturation level) and the relationship between the concentration of lithium chloride and the sensor output corresponding to the reducing current with the normal concentration mentioned above.

These relationships led to the discovery that response time becomes shorter with increasing lithium chloride concentration, up to approximately 1 mole, without exerting significant influence on the sensor output or detectivity.

Increasing the concentration of lithium chloride beyond 2.0 moles to a saturation level, though showing the same tendency, is economically disadvantageous because it results in unnecessary waste of material.

Instead of lithium chloride used in the embodiment described above, a solution of other substance, such as potassium chloride, also may be used as the electrolyte. Potassium chloride whose concentration is adjusted to between approximately 0.5 and 1.0 mole or the limit of saturation solubility improves response speed as done by lithium chloride, as shown in FIG. 3. Potassium chloride saves the need for economic considerations because the saturation limit reaches at a little over 1 mole.

As has been described, the cell according to this invention which holds an electrolyte solution of not less than 0.5 mole and not more than 2.0 moles lithium chloride, has a window sealed with a gas-permeable diaphragm holding a working electrode attached to that side thereof which faces the electrolyte solution, and also holds a counter electrode permits improving response speed without causing changes in detectivity.

What we claim is:

1. A constant-potential coulometric gas sensor comprises a cell having a window containing an electrolyte solution of not less than 0.5 mole and not more than 2.0 moles lithium chloride, the cell having a window sealed with a gas-permeable diaphragm holding a working electrode attached to that side thereof which faces the electrolyte solution, and a counter electrode, with a given amount of potential applied to the working electrode to generate a measurement signal based on the electrolytic current corresponding to the concentration of ammonia gas present.

2. A constant-potential coulometric gas sensor comprises a cell having a window containing an electrolyte solution of not less than 0.5 mole and not more than 1.0 mole potassium chloride, the cell having a window sealed with a gas-permeable diaphragm holding a working electrode attached to that side thereof which faces the electrolyte solution, and a counter electrode, with a given amount of potential applied to the working electrode to generate a measurement signal based on the electrolytic current corresponding to the concentration of ammonia gas present.
